(19) United States
(12) Patent Application Publication
(10) Pub. No.: US 2010/0235383 A1
(43) Pub. Date: Sep. 16, 2010

(54) STORAGE SYSTEM AND DATA MIGRATION-COMPATIBLE SEARCH SYSTEM

(75) Inventors: Hideyuki KASHIWASE, Tokyo (JP); Kazuki NAKANISHI, Tokyo (JP); Masaki IMAGAWA, Tokyo (JP); Takashi IMAI, Tokyo (JP)

Correspondence Address: MATTINGLY & MALUR, P.C., 1800 DIAGONAL ROAD, SUITE 370, ALEXANDRIA, VA, 22314, US

(73) Assignee: HITACHI SOFTWARE ENGINEERING CO., LTD., Tokyo (JP)

(21) Appl. No.: 12/698,256

(22) Filed: Feb. 2, 2010

(30) Foreign Application Priority Data
Mar. 11, 2009 (JP) 2009-058529

(51) Int. Cl. G06F 17/30; G06F 12/00

(52) U.S. Cl. 707/769; 711/216; 707/705; 707/E17.014; 707/E17.002

(57) ABSTRACT

To reduce consumption of the data capacity of a data migration-source storage by information necessary for accessing entity data that has been migrated to the other storage, compared to that of the conventional system. Provided is a storage system including a first storage that is a migration-destination storage having stored therein entity data and first index information associated with the entity data, and a second storage that is a migration-source storage having stored therein link information for accessing the entity data and second index information associated with the link information, wherein the second index information includes the same hash value as a hash value included in the first index information.

### BACKGROUND OF THE INVENTION

1. Field of the Invention

The present invention relates to a storage system in which data is migrated from one storage to another and to a search system that conducts a search of such a storage system.

2. Background Art

FIG. 1 illustrates a schematic configuration diagram of a conventionally used search processing system 100. The search processing system 100 illustrated in FIG. 1 is composed mainly of an input portion 101, a search system 103 (a search processing portion 102), storages 104 and 105, and a display device 107. Among such components, the input portion 101 is a device used to enter search keywords. The search system 103 is implemented as a so-called computer system. On the search system 103, the search processing portion 102 is mounted as one of the functions of programs executed on the computer. The search processing portion 102 generates a search query in response to a search keyword entered via the input portion 101, and executes a search of the storage 104.

The storage 104 and the storage 105 together form a storage system as a whole. In FIG. 1, the storage 104 has stored therein both file entity data 104a, which is a search target (a file to be searched for), and index information 104b thereof. In FIG. 1, the storage 105 is used to back up data in the storage 104. Thus, the storage 105 has stored therein the same data as the data in the storage 104. That is, the storage 105 has stored therein both file entity data 105a and index information 105b thereof.

In the search processing system 100, file search operations are executed in the following procedures. First, a user enters a search keyword via the search input portion 101. The search processing portion 102, upon detecting the entry, generates a search query based on the entered search keyword, and executes search processing to the storage 104 having stored therein the target data. As a result, if the file entity data 104a is hit, the search hit result is read by the search processing portion 102 via the index information 104b associated with the file, and is displayed on the display device 107 as a list of search results. In this manner, when file entity data resides in the storage 104, the search operation is executed directly to the entity data 104a stored in the storage 104.

It should be noted that when entity data is replicated for management as illustrated in FIG. 1, the entity data 105a corresponding to the search result also resides in a place (the storage 105) other than the place (the storage 104) displayed as the search result. In this case, the file entity data 104a and 105a have the same content, and the index information 104b and 105b associated with such files also have the same content. Typically, the size of index information tends to increase as the size of file entity data including contents increases. Reference 1 (JP Patent Publication (Kokai) No. 2000-10980 A) discloses a system in which a search result such as the one described above is obtained not via the direct path of index information but via a given identifier.

### SUMMARY OF THE INVENTION

In the field of data storage, a storage system is typically constructed by combining a high-speed, low-capacity disk device with a low-speed, high-capacity disk device. For storage systems of such a kind, a data management technique called data migration is typically adopted. It should be noted that the term “data migration” includes a variety of meanings. In this specification, the term “data migration” is used to refer to a case in which, when a file has been migrated from a source storage to a destination storage, information for accessing the migrated file remains in the source storage.

For example, in the aforementioned example, the term “data migration” is used for the following case: when the entity data has been migrated from the source storage to the destination storage, information for accessing the migrated entity data remains in the source storage. In the following description, a storage from which data is migrated is also referred to as a “migration-source storage,” and a storage to which the data is migrated is also referred to as a “migration-destination storage.”

In recent years, electronic text has come to be handled equivalently to written documents, gaining in importance. Further, the data volume of electronic text has also been expanding with an increase in its importance. In such a context, a mechanism is demanded that can search for unstructured electronic text at high speed. Meanwhile, a mechanism is also demanded that can handle files and search for files as appropriate without making users aware of data migration being executed for data management purposes.

This is because data migration between storages in a storage system is executed only for convenience of management of files, and could increase the workload of a user who just wants to search for a file. Furthermore, if the entity data stored in the file migration-destination storage is displayed as a search result on the display device 107, the storage location of the data becomes known to a user, which is unfavorable if the storage location should not be presented to the user. In addition, since index information of a file containing contents typically has a large data size, such index information could disadvantageously consume a greater part of the limited data capacity. Such disadvantages can be compensated for by using a mechanism called data replication in which data is replicated.

However, the size of the index information stored in the migration-source storage still depends on the size of the entity data. Thus, there remains a problem that the information for accessing the entity data stored in the migration-destination storage could consume a greater part of the data capacity of the expensive, low-capacity storage that is accessible at high speed.

Accordingly, the present invention proposes a storage system in which entity data and first index information associated with the entity data are migrated to a first storage, which is a migration-destination storage, by executing data migration, and link information for accessing the migrated first index information and second index information associated with the link information are stored in a second storage, which is a migration-source storage, wherein the second index information includes the same hash value as a hash value included in the first index information.

The present invention proposes a search system that executes the following search processing to the aforementioned storage system. That is, a search processing system is proposed that automatically creates a search query corresponding to a search keyword entered via a user interface, searches for entity data that matches the search query, and displays, when matching entity data is determined to be present, only the link information for accessing the entity data that matches the search keyword, on a display screen as a search result.

Link information that indicates a link to entity data typically has a smaller data size than the entity data. Thus, the data size of the second index information associated with the link information is smaller than the data size of the first index information associated with the entity data. Thus, the present invention makes it possible to reduce consumption of the data capacity of the data migration-source storage by the storage therein of information necessary for accessing the entity data that has been migrated to the other storage, compared to that of the conventional system. Accordingly, it is possible to effectively utilize the expensive, low-capacity migration-source storage that is accessible at high speed.

In the present invention, only the migration-source storage is presented as a search result to users even when the entity data has been migrated to the other storage by data migration. Thus, it is possible to make users unaware of the execution of data migration that is not directly related to the users.

### BRIEF DESCRIPTION OF THE DRAWINGS

In the accompanying drawings:

FIG. 1 illustrates a conventional storage system and search system.

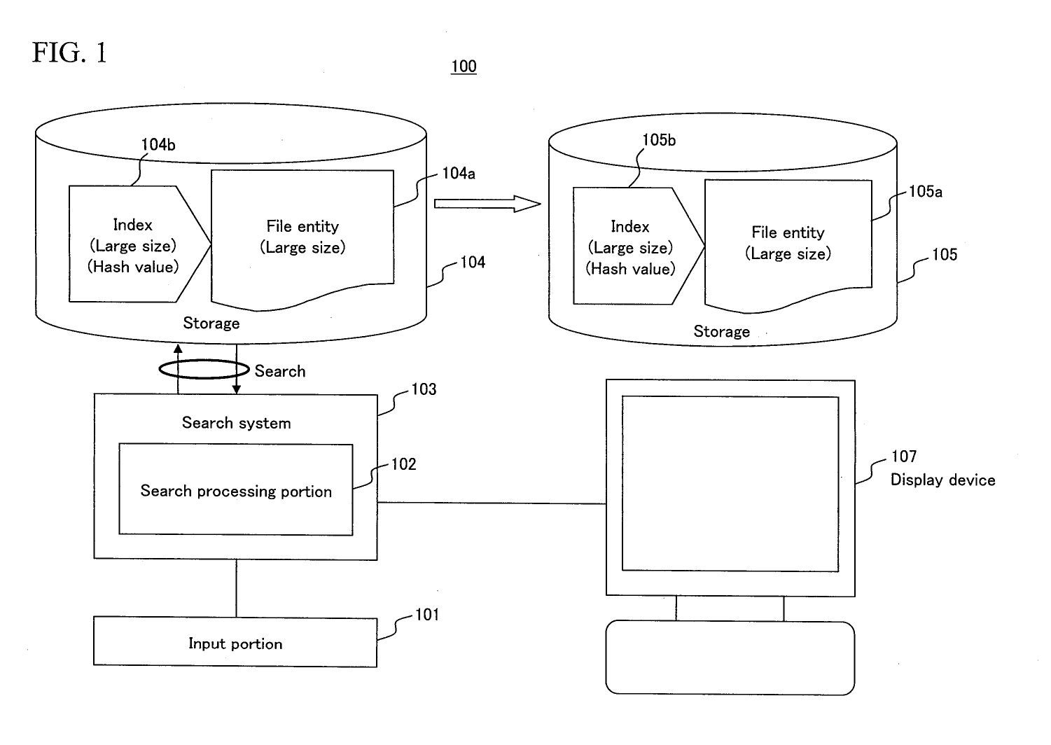

FIG. 2 illustrates an example of a storage system and search system in accordance with an embodiment;

FIGS. 3A and 3B illustrate a change of data by the data migration executed in accordance with an embodiment;

FIG. 4 illustrates a change of a file by the data migration executed in accordance with an embodiment;

FIG. 5 illustrates the search processing operation (a first step) in accordance with an embodiment;

FIG. 6 illustrates the search processing operation (a second step) in accordance with an embodiment;

FIG. 7 illustrates the overall image of the search processing operation in accordance with an embodiment;

FIG. 8 is a flowchart illustrating the search processing operation in accordance with an embodiment; and

FIG. 9 illustrates a view of the operation of converting a search query in accordance with an embodiment.

### DESCRIPTION OF SYMBOLS

100 search processing system (conventional)
200 search processing system (embodiment)
201 migration-source storage
201a index information (migration source)
201b link information
202a index information (migration destination)
202b file entity data
202 migration-destination storage
203 migration-compatible search system
204 input portion
205 display device

### DETAILED DESCRIPTION OF THE PREFERRED EMBODIMENTS

Hereinafter, embodiments for carrying out the present invention will be described in detail with reference to the accompanying drawings.

### (1) Embodiment 1

### (1-1) Overall Configuration of the Search System (Storage System)

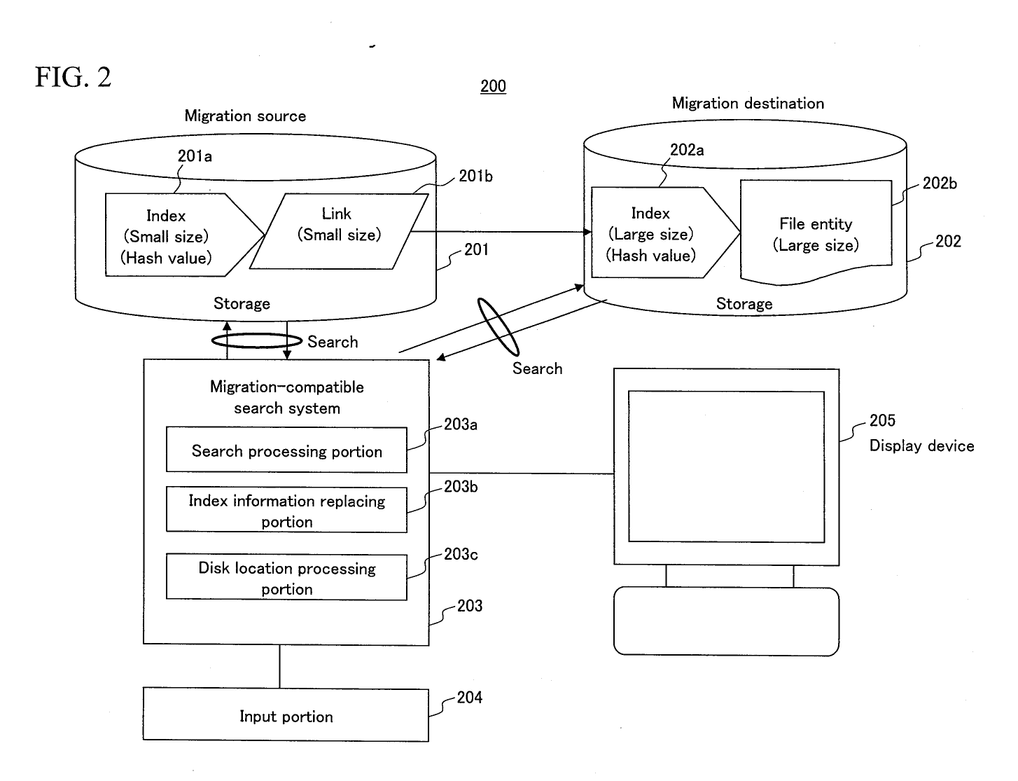

FIG. 2 illustrates the schematic configuration of a search processing system 200 in accordance with the present embodiment. As illustrated in FIG. 2, the search processing system 200 is composed mainly of an input portion 204, a migration-compatible search system 203, storages 201 and 202, and a display device 205. It is assumed that data management by data migration has already been executed to the storage system (the storages 201 and 202) that is the search target of the search processing system 200 in accordance with the present embodiment. In FIG. 2, the storage 201 is a migration-source storage and the storage 202 is a migration-destination storage.

The migration-compatible search system 203 is implemented as a so-called computer system. That is, the migration-compatible search system 203 includes an arithmetic logic unit, a control circuit, a storage device, and an input/output device. The migration-compatible search system 203 has mounted thereon a search processing portion 203a, an index information replacing portion 203b, and a disk location processing portion 203c that are implemented by programs executed on the computer. The migration-compatible search system 203 executes a search processing operation, via the three processing functions, to the storage system as a search target. Each processing function will be described in detail later. Such three processing functions are extracted only for illustration purposes from the perspective of search processing. Thus, the migration-compatible search system 203 also has processing functions other than these.

The input portion 204 is a device used to enter search keywords and control. For example, the input portion 204 includes a keyboard, a mouse, a touch pen, and other devices. The input portion 204 is also implemented as part of a user interface screen displayed on the screen of the display device 205. The display device 205 is a device that displays search results. For example, a liquid crystal display device, a plasma display device, or other display devices can be used.

### (1-2) Migration Operation

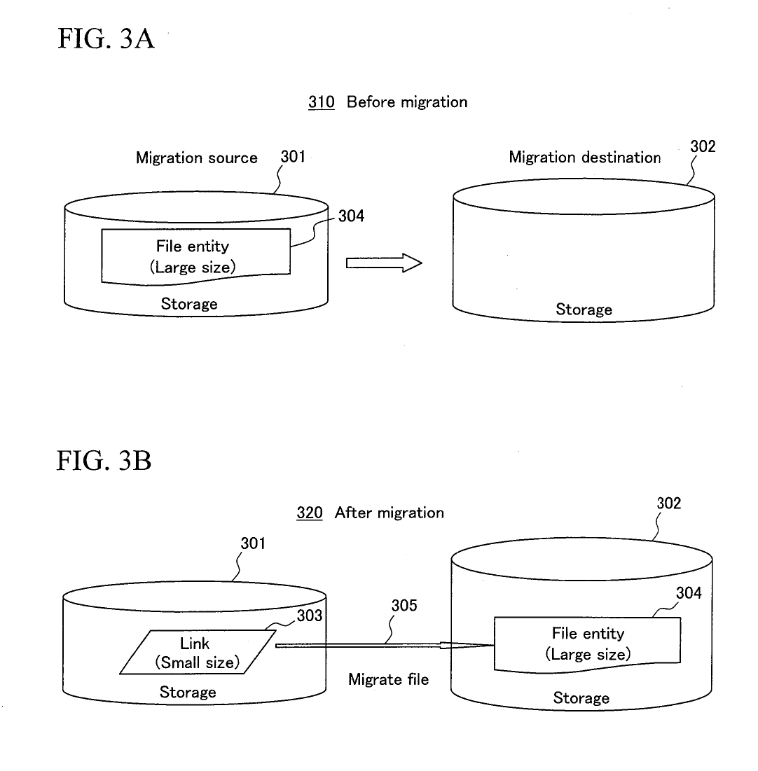

FIGS. 3A and 3B illustrate a change in data structure by the execution of data migration. FIG. 3A illustrates a data structure 310 before the data migration, and FIG. 3B illustrates a data structure 320 after the data migration. In the drawings, a storage 301 is a migration-source storage and a storage 302 is a migration-destination storage.

In typical storage systems that apply data management based on data migration, an expensive, low-capacity storage that is accessible at high speed is used for a migration-source storage. Frequently used file data is stored in the storage 301. Then, files that have come to be used less frequently are migrated, through the execution of data migration, to an inexpensive, high-capacity storage that is accessible at low speed. The storage to which such files are migrated is the migration-destination storage 302.

In the data migration in accordance with the present embodiment, only file entity data 304 is migrated to the migration-destination storage 302 (305). Meanwhile, only link information 303 of the file remains in the migration-source storage 301 so as to allow the migrated entity data 304 to be accessible through the link information 303. Such data migration is advantageous in that the used capacity of the migration-source storage (e.g., a hard disk device) can be suppressed. In addition, since the link information remaining in the migration-source storage can be presented as a search result, the file entity data can be handled via such link information. As a result, users can conduct a search for a file without being aware of the data migration executed in the storage system. In addition, another advantage can be provided in that users need not directly handle the entity data stored in the migration-destination storage.

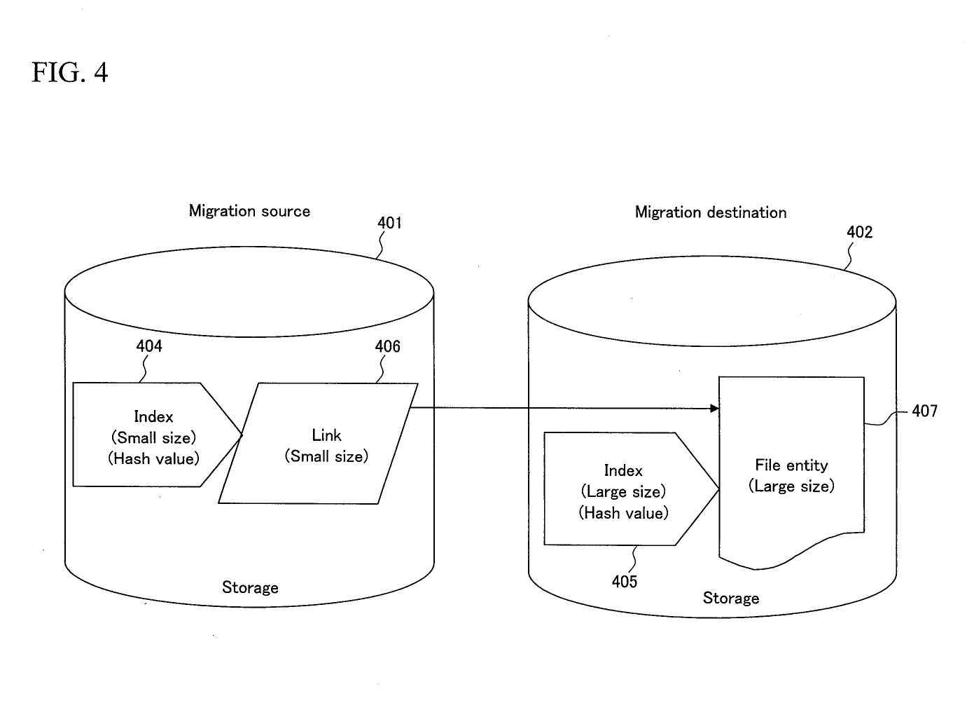

Next, a file structure generated by the execution of the data migration in accordance with the present embodiment will be described with reference to FIG. 4. In FIG. 4, a storage 401 is a migration-source storage, and a storage 402 is a migration-destination storage.

In this embodiment, the migration-source storage 401 has stored therein link information 406 and index information 404 thereof as a file. The index information 404 herein is data associated with the link information 406, and includes, for example, a hash value that can uniquely identify the link information 406.

Meanwhile, the migration-destination storage 402 has stored therein file entity data 407 and index information 405 thereof as a file. The index information 405 herein is data associated with the entity data 407, and includes, for example, a hash value that can uniquely identify the entity data 407.

It should be noted that the hash value that can uniquely identify the entity data 407 is also stored in the index information 404 associated with the link information 406. Thus, once the index information 405 of the file entity data 407 can be obtained, it becomes also possible to identify the link information 406 via the index information 404 having the same hash value as the index information 405.

The file entity data 407 typically includes content data that is the content of a file. Thus, the file size of the file entity data 407 is typically larger than the file size of the link information 406. In contrast, the link information 406 does not include content data that is the content of a file. Thus, the file size of the link information 406 is typically smaller than the file size of the entity data 407. Thus, the index information 404 of the link information 406 is also smaller than the index information 405 of the file entity data 407. That is, the data size of the index information 404 can be smaller than the data size of the index information 405.

### (1-3) Search Processing Operation

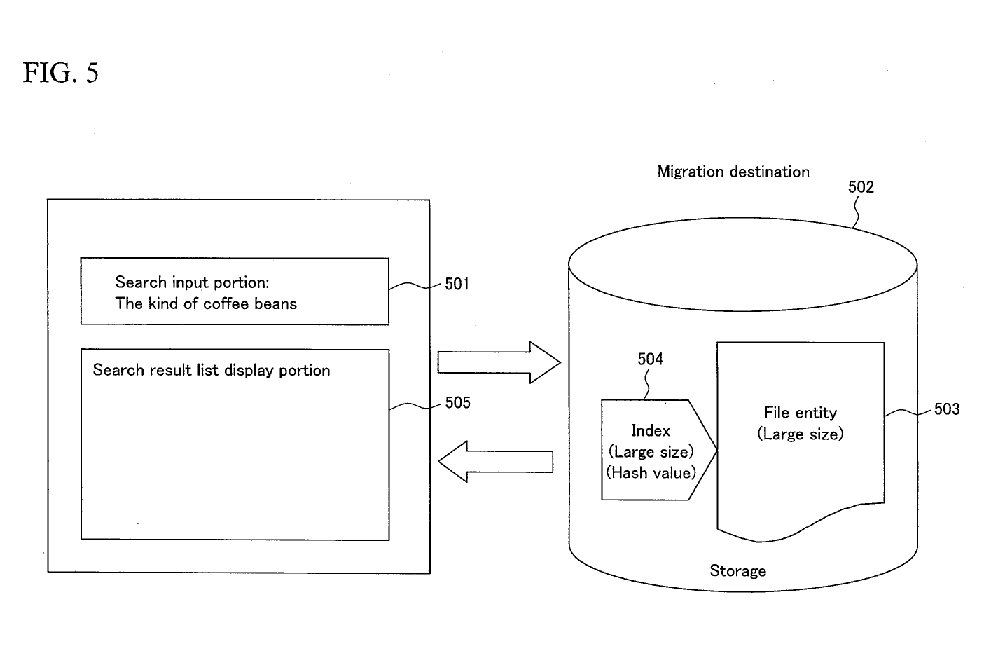

Next, a search processing operation on the storage system in which the aforementioned data migration has been executed will be described. In this embodiment, the search processing portion 203a executes the search processing in two steps. First, the search processing operation of the first step executed by the search processing portion 203a will be described with reference to FIG. 5.

The search processing operation of the first step is initiated upon entry, by a user, of a search keyword, which is included in the content of a file, into a search input portion 501 and entry of a command for executing a search. The search input portion 501 herein is implemented as one of the functions provided by the search processing portion 203a. FIG. 5 illustrates a case in which “the kind of coffee beans” is entered as a search keyword. The search processing of the first step is executed to the entire storage system. However, if it has been known beforehand that the entity data 202b does not reside in the migration-source storage as a result of the execution of data migration, the search processing of the first step can be executed only to the migration-destination storage.

It should be noted that such narrowing of the search area is executed by the disk location processing portion 203c that has a function of managing the execution step of the search processing and a function of storing the system configuration of the storage system as well as the execution status of data migration. For example, when data migration has not been executed to the storage system, the disk location processing portion 203c sets all of the storages that constitute the storage system as the search targets. Meanwhile, when data migration has already been executed to the storage system, the disk location processing portion 203c sets only the migration-destination storage as the search target. In addition, when the execution step of the search processing is in the first step, for example, the disk location processing portion 203c sets the migration-destination storage as the search target. FIG. 5 illustrates a case in which the search processing of the first step is executed only to a migration-destination storage 502.

In the search processing of the first step, entity data 503 including a search keyword that matches the search condition is identified based on the search query, and index information 504 corresponding to the entity data 503 is identified. Accordingly, the search processing portion 203a obtains the hash value of the index information 504 as information on the return value for the search query. In usual searches, search results are displayed on a search result list display portion 505 at this stage. However, the search system in accordance with the present embodiment does not display the search results at this time because the migration-destination storage 502 is not preferred to be presented as a file storage location to users.

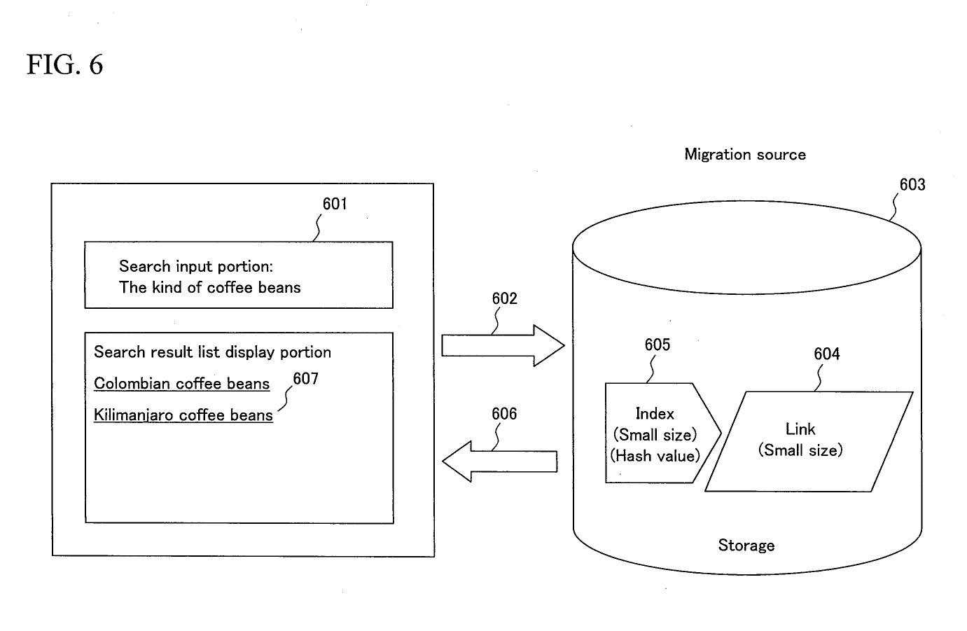

Next, the search processing operation of the second step executed by the search processing portion 203a will be described with reference to FIG. 6. The search processing operation of the second step is executed based on a search query that is automatically re-created based on the hash value of the index information 504 that is the search result of the first step (602). The operation of re-creating the search query is automatically executed by the index information replacing portion 203b. That is, the re-creation operation is executed as part of the processing of a program. Thus, users need not re-enter a search keyword into a search input portion 601.

In the search processing operation of the second step, the search processing portion 203a executes search processing based on the hash value of the index information 504 that has been previously obtained. Then, link information 604 or the index information 504 of the file entity data 503 is hit via the index information 605, which includes the same hash value as the index information 504, of the link information 604. However, if search processing is executed without any storage specified in this manner, a file in the migration-destination storage 502 could also be hit. Thus, in the present embodiment, the search scope is narrowed by setting only the migration-source storage 603 as the search target with the use of the disk location processing portion 203c. Thus, in the present embodiment, the search processing portion 203a obtains only the link information 604 in the migration-source storage 603 as a search result 606 through the search processing operation of the second step.

Thereafter, the search processing portion 203a creates a list of search results based on the link information 604 obtained as the search result 606, and displays the list on the screen of the display device 205. Such a display screen will be hereinafter referred to as a search result list display portion 607. The search result list display portion 607 displays information on the entity data, which was a hit in the search processing, with embedded therein the link information 604 for accessing the entity data. As a result, users can access the link information 604 stored in the migration-source storage 603 through the operation of clicking the search result displayed on the search result list display portion 607, and can further refer to the file entity data via the link information 604.

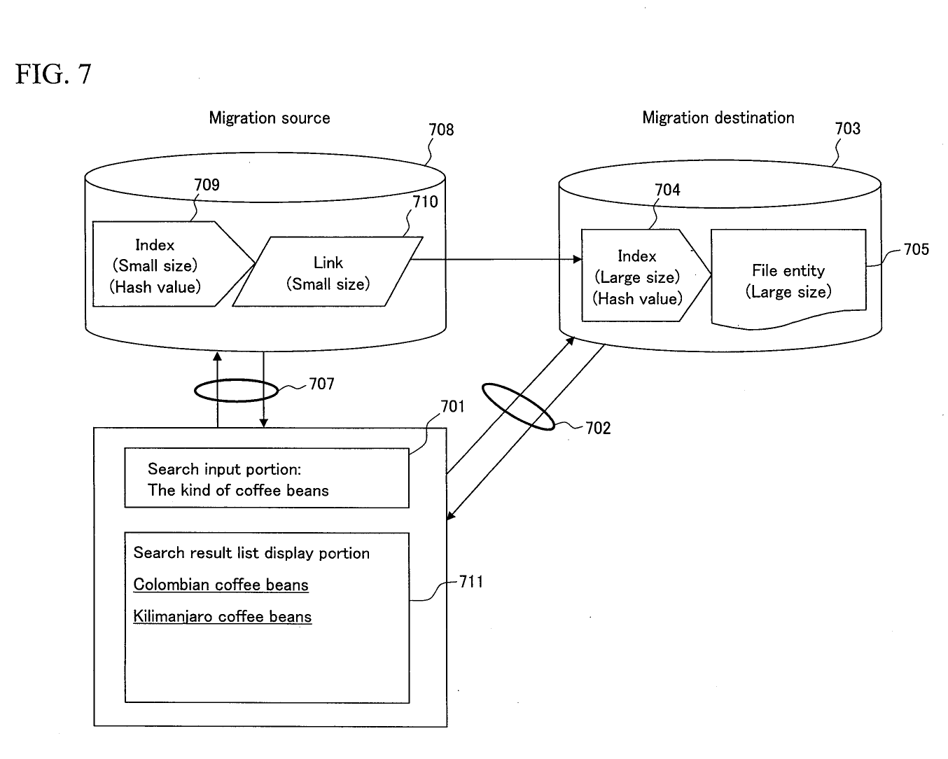

The overall operation, from the start to the end of the aforementioned search processing operation, will now be described with reference to FIG. 7. First, a user enters a search keyword into a search input portion 701. Then, the search processing portion 203a executes a search operation 702 of the first step. In this case, the search processing portion 203a, in cooperation with the disk location processing portion 203c, executes a search operation to a migration-destination storage 703 as the search target location. In this embodiment, entity data 705 stored in the storage 703 that matches the search keyword is hit. Then, the search processing portion 203a obtains index information 704 of the hit entity data 705 as a return value. Thereafter, the search processing portion 203a gives the return value to the index information replacing portion 203b, and embeds a hash value included in the index information as a return value into the search query. Then, the search processing portion 203a, in cooperation with the disk location processing portion 203c, adds to the search query a search location condition that limits the search target location to a migration-source storage 708.

Thereafter, the search processing portion 203a automatically executes a search operation 707 of the second step. The search operation 707 of the second step is executed based on the newly created search query. In this embodiment, index information 709 in the storage 708 that matches the search query is hit. The index information 709 is associated with the link information 710. Thus, the search processing portion 203a obtains the link information 710 as a search result via the hit index information 709. Thereafter, the search processing portion 203a displays information on the thus obtained link information 710 as a search result on a search result list display portion 711.

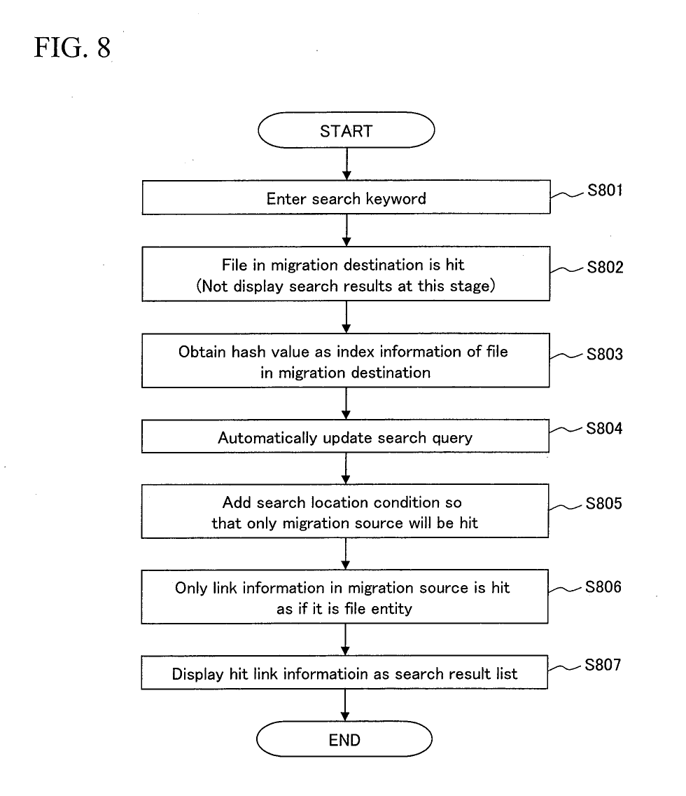

FIG. 8 illustrates a flowchart corresponding to the processing operation of the aforementioned migration-compatible search system 203. Hereinafter, the overall processing operation of the migration-compatible search system 203 will be described in accordance with the flowchart illustrated in FIG. 8.

First, a user enters a search keyword into the search input portion 501 (step 801). Then, the search processing portion 203a executes the search operation of the first step based on the search keyword (step 802). In this embodiment, a file (the entity data 202b) that includes the search keyword in the migration-destination storage 202 is hit.

Herein, if the search target is not limited to the migration-destination storage 202, there is a possibility that a file (the entity data 201b) that includes the search keyword in the migration-source storage 201 may be hit. In such a case, the processing of the search processing portion 203a immediately proceeds to the processing of step 806 which is described later. For example, when data migration processing has not been executed to the storage system or when the migration-source storage 201 still has a target file stored therein even after data migration has been executed, there is a possibility that a search operation may be executed to the entire storage system. It should be noted that search results obtained in step 802 are not displayed on the screen.

Thereafter, the search processing portion 203a obtains a hash value from the index information 202a associated with the hit file (entity data) (step 803). Next, the search processing portion 203a automatically updates the search query based on the obtained hash value (step 804). Further, the search processing portion 203a adds to the updated search query a search condition that specifies the migration-source storage to be searched so that only the link information in the migration-source storage will be hit (step 805). Thereafter, the search processing portion 203a executes the search processing of the second step based on the changed search query, and obtains as a search result (link information) the link information 201b identified via the index information 201a in the migration-source storage 201 (step 806). Then, the search processing portion 203a displays a list of link information as the obtained search results on the screen of the search result list display portion corresponding to the entered search keyword (step 807).

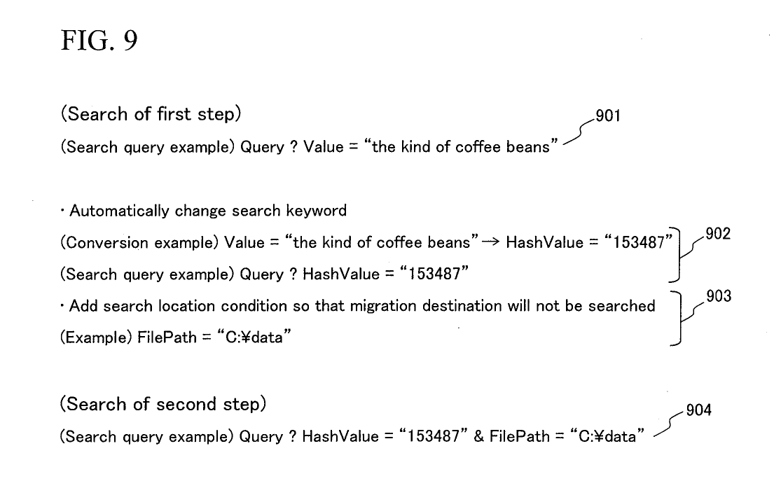

FIG. 9 illustrates an example of a search query used by the search processing portion 203a and an image of the process of changing the search query. FIG. 9 represents a case in which a user entered “the kind of coffee beans” as a search keyword. First, a search query is created upon entry of the search keyword (901). As illustrated in FIG. 9, a search query at the time of entry is given by the entered text. Here, suppose that the search processing of the first step was executed based on the search keyword, and a hash value “153487” was obtained from index information corresponding to the hit entity data. In this case, the value “the kind of coffee beans” of the search query is converted into the hash value “153487” as illustrated in FIG. 9 (902). That is, the search query is converted into HashValue=“153487.” Thereafter, a search condition that specifies the migration destination to be excluded from the search target location in the second step is newly added (903). In FIG. 9, “C:¥data” is added as a file path that specifies the search target location. As a result, the search query for use in the search processing of the second step is changed to HashValue=“153487” & FilePath=“C:¥data” (904).

### (1-4) Advantageous Effects of the Embodiment

As described above, using the migration operation in accordance with the present embodiment makes it possible to significantly reduce the residual volume of data stored in the migration-source storage as compared to that of the conventional method (a method in which index information of entity data is stored in the migration-source storage). This in turn can increase the free space of the storage used as the migration source. Accordingly, it is possible to store frequently-used data in the migration-source storage that is an expensive, low-capacity storage accessible at high speed. It is also possible to reduce the frequency of execution of migration.

The search system in accordance with the present embodiment executes a search operation through the following two steps: a search operation of the first step that includes searching at least the migration-destination storage and obtaining index information associated with entity data that matches the search condition, and a search operation of the second step that includes changing, based on the obtained index information, the search condition so that only the index information stored in the migration-source storage will be searched for, and obtaining link information that matches the search condition.

Through the two-step search processing described above, it is possible to present to a user who is executing a search operation only the link information that resides in the migration-source storage as a search result. That is, it is possible to present only the migration-source storage having stored therein the link information as a storage location of the information. As a result, the migration-destination storage in which the entity data resides can be handled as a “black box.” Accordingly, it is possible to make users unaware of the execution of migration as well as the data management scheme.

### (2) Other Embodiments

Although the aforementioned embodiment illustrates a case in which the number of migration-source storages and the number of migration-destination storages are each one, the system configuration is not limited to this. For example, a plurality of migration-destination storages may be provided and such a plurality of storages may be managed in a hierarchical fashion.

The storage system and search system of the aforementioned embodiment can be provided not only in the same building but also in different buildings in a distributed fashion. Further, the aforementioned storage system and search system can be constructed such that they are provided across countries or areas equivalent to countries.

The storage system and search system can be operated by either the same enterprise or different enterprises.

Although the aforementioned embodiment illustrates a case in which each of the migration-source storage and the migration-destination storage is a hard disk device, the migration-source storage can be a semiconductor recording medium. In addition, the migration-destination storage can be a device that records/reproduces data on/from an optical recording medium or a device that records/reproduces data on/from a tape recording medium.

Further, although the aforementioned embodiment illustrates a case in which each of the search processing portion 203a, the index information replacing portion 203b, and the disk location processing portion 203c that constitute the migration-compatible search system 203 is implemented as part of the functions of computer programs, all or some of such functions can be implemented as hardware. In addition, programs corresponding to the search processing portion 203a, the index information replacing portion 203b, and the disk location processing portion 203c can be distributed in a state of being stored in a recording medium or distributed as part of broadcast signals or communication signals.

What is claimed is:

1. A storage system comprising:
a first storage that is a migration-destination storage having stored therein entity data and first index information associated with the entity data; and
a second storage that is a migration-source storage having stored therein link information for accessing the entity data and second index information associated with the link information, the second index information including the same hash value as a hash value included in the first index information.

2. A data migration-compatible search system comprising a search processing portion that executes search processing to a storage system, the storage system including a first storage that is a migration-destination storage having stored therein entity data and first index information associated with the entity data, and a second storage that is a migration-source storage having stored therein link information for accessing the entity data and second index information associated with the link information, the second index information including the same hash value as a hash value included in the first index information,
wherein the search processing portion executes the following data processing: automatically creating a search query corresponding to a search keyword entered via a user interface, searching at least the first storage based on the search query, and displaying, when entity data that matches the search query is determined to be present, the link information for accessing the matching entity data on a display screen as a search result.

3. The data migration-compatible search system according to claim 2, further comprising an index information replacing portion that, upon detection of entity data that matches the search query in the first storage, obtains the hash value from the first index information associated with the entity data, and executes data processing of automatically creating a new search query specifying the hash value as a search condition, wherein
the search processing portion executes data processing of searching for the link information based on the search query specifying the hash value as the search condition.

4. The data migration-compatible search system according to claim 3, further comprising a disk location processing portion that executes data processing of adding a new search condition for narrowing a search scope to the second storage, to the search query newly created by the index information replacing portion, the search query specifying the hash value as the search condition.

5. The data migration-compatible search system according to claim 2, wherein the search processing portion, even when entity data that matches the search keyword has been detected in the first storage during the execution of the search processing, does not display the storage location of the entity data as a search result on the display screen.

6. The data migration-compatible search system according to claim 3, wherein the search processing portion, even when entity data that matches the search keyword has been detected in the first storage during the execution of the search processing, does not display the storage location of the entity data as a search result on the display screen.

7. The data migration-compatible search system according to claim 4, wherein the search processing portion, even when entity data that matches the search keyword has been detected in the first storage during the execution of the search processing, does not display the storage location of the entity data as a search result on the display screen.
